(19) United States
(12) Patent Application Publication
(10) Pub. No.: US 2006/0206302 A1
(43) Pub. Date: Sep. 14, 2006

(54) Physicians' way of information productions

(76) Inventor: Anuthep Banja-Athon, New York, NY (US)

Correspondence Address: ANUTHEP BENJA-ATHON M.D., 210 E 36th St., New York, NY, 10016, US

(21) Appl. No.: 11/022,410

(22) Filed: Dec. 27, 2004

(51) Int. Cl. G06F 17/20

(52) U.S. Cl. 704/1

(57) ABSTRACT

The method of efficient dictations to facilitating individuals' productions and transcriptions of speeches comprising medical information comprises repertories of words, sequences, synopses and categories words which are used by individuals for dictations to repetitively produce the desired and predictable outcomes.

This application is a continuation-in-part of a patent application docket number ABA1204 filed Dec. 4, 2004 entitled The Method of Curbing Health-Care Costs which is pending.

### FIELD OF INVENTION

The efficient method of dictating medical information.

### BACKGROUND OF THE INVENTION

Prior to the existence of health insurance companies, physicians were able to treat patients without much, if any, record keeping. In fact, just a few decades ago, in many circumstances, records on patients were not commonly generated by physicians.

However, during that time, America witnessed the burgeoning growth of the healthcare industry and the third-parties in the patient-physician relationship. The industry and parties continues to demand and acquire records of patients as a means for business transaction. Consequently, physicians are being compelled to generate tons of records for one common albeit poor reason to satisfy the industry's and the third-parties' demand. So, physicians continue to mostly write, less dictate and transcribe tons of long and tedious medical notes for the above. As described in the pending patent application supra, physicians are compelled to waste hundreds of millions of hours or lose about 140 billion dollars per annum doing the above choirs.

Neither vision, desire, means, know how, effort nor prior art were heretofore had or made to get rid of the above redundancies, interpositions or behaviors in healthcare—a reason why the current healthcare crisis could never heretofore be solved by all, if any, prior art.

However, the present invention teaches the method and provides the means which the pending patent application supra did not teach and further maximizes the power of said pending application and objectives as explained in said pending application.

### SUMMARY OF THE INVENTION

The productions of patients' records and information by physicians are random, tedious and tremendously inefficient and the products are unreliable, unpredictable and, often, of poor quality and, if not useless, are limited in value.

The present invention is a method of efficient dictations facilitating individuals' productions and transcriptions of speeches comprising medical information comprises repertories of words, sequences, synopses and categories words which are used by individuals for dictations to repetitively produce the desired, predictable and consistent outcomes which are organized and useful.

### DESCRIPTION OF THE PREFERRED EMBODIMENTS

The present invention is the method of efficient dictations by individuals adaptable to facilitate and economize individuals' speaking process in the productions of speeches comprising medical information and transcriptions of medical information.

The present invention comprises a means for abbreviating medical information so that the redundant words and speech production processes involving the use and repetitions of redundant and useless words of prior art are reduced or eliminated. In other words, the present invention teaches the efficient means of dictations by individuals such as, but not limited to, physicians, physician assistants, nurses and dentists.

The present invention comprises a plurality of words such as medical and non-medical words, the former being more abundant than the latter. In other words, non-medical words are mostly, if not totally, reduced or removed. According to the medical algorithms, these words are organized into repertories of sequences and/or synopses (plural of synopsis), contractions, summaries, extractions and abridgements of words. According to the medical algorithms, said repertories are further organized into categories of plurality of sequences and/or synopses of words.

Said categories sequences of words comprises of individual categories relating to the human anatomy, symptoms, complaints and manifestations, signs, findings and manifestations, and diseases, illnesses and disorders. Similarly, said categories of synopses of words comprises individual categories relating to the human anatomy, symptoms, complaints and manifestations, signs, findings and manifestations, and diseases, illnesses, disorders and diagnoses.

For example, a physician having seen a patient using the present invention dictates using the 4 categories of sequences and/or synopses of words: “ . . . left face (pause) tingling, pain (pause) loss of muscular movements, poor eye closure, tearing, facial paralysis (pause) Bell's palsy, rule out Lyme disease, hypertension, diabetes”. Thus, if there are 100,000 Bell's palsy patients in America seeing 100,000 physicians in a given year, these physicians will economically dictate and produce more than 100,000 similar or almost similar said medical information which are useful to all concerned. Overall, the processes of the present invention facilitate the economic and useful productions of billions of similarities and/or analogies for all diseases, disorders and illnesses by said individuals each year.

Therefore, the present invention provides the method and means for said individuals to achieve the goals and objectives of the present and said pending patents.

Although the preferred embodiments have been described, it will be appreciated by those skilled in art that variations, adaptations and applications of the present invention can be had without departing from the spirit of the invention and the scope of the claims.

1. A method of dictations adaptable to facilitate individuals' productions of speeches comprising medical information comprises:
a means for abbreviating medical information;
a process of dictating said means for abbreviating medical information;
a process of dictating a repertory of sequences of words comprising sequences of words;
a process of dictating a plurality of categories of sequences of words comprising sequences of words;
a process of dictating a repertory of synopses of words comprising synopses of words; and
a process of dictating a plurality of categories of synopses of words comprising synopses of words.

2. The method of dictation according to claim 1 wherein said means for abbreviating medical information comprises a plurality of words.

3. The method of dictation according to claim 1 wherein said means for abbreviating medical information comprises a repertory of sequences of words.

4. The method of dictation according to claim 1 wherein said means for abbreviating medical information comprises a repertory of synopses of words.

5. The method of dictation according to claim 1 wherein said means for abbreviating medical information comprises categories of sequences of words.

6. The method of dictation according to claim 1 wherein said means for abbreviating medical information comprises categories of synopses of words.

7. A category of sequences of words of the categories of sequences of words according to claim 5 comprises sequences of words relating to the human anatomy.

8. A category of sequences of words of the categories of sequences of words according to claim 5 comprises sequences of words relating to symptoms, complaints and manifestations.

9. A category of sequences of words of the categories of sequences of words according to claim 5 comprises sequences of words relating to signs, findings and manifestations.

10. A category of sequences of words of the categories of sequences of words according to claim 5 comprises sequences of words relating to diseases, illnesses and disorders.

11. A category of synopses of words of the categories of synopses of words according to claim 6 comprises synopses of words relating to the human anatomy.

12. A category of synopses of words of the categories of synopses of words according to claim 6 comprises synopses of words relating to symptoms, complaints and manifestations.

13. A category of synopses of words of the categories of synopses of words according to claim 6 comprises synopses of words relating to signs, findings and manifestations.

14. A category of synopses of words of the categories of synopses of words according to claim 6 comprises synopses of words relating to diseases, illnesses and disorders.

15. The method of dictation according to claim 1 wherein said process of dictating said means for abbreviating medical information comprises a process of dictating a plurality of sequences of words.

16. The method of dictation according to claim 1 wherein said process of dictating said means for abbreviating medical information comprises a process of dictating a plurality of synopses of words.

17. The method of dictation according to claim 1 wherein said process of dictating said means for abbreviating medical information comprises a process of dictating sequences of words of categories of sequences of words.

18. The method of dictation according to claim 1 wherein said process of dictating said means for abbreviating medical information comprises a process of dictating synopses of words of categories of synopses of words.

19. A method of efficient dictations adaptable to economize individuals' speaking process in the productions of speeches comprising medical information comprises:
a means for abbreviating medical information;
a process of dictating said means for abbreviating medical information;
a process of dictating a repertory of sequences of words comprising sequences of words;
a process of dictating a plurality of categories of sequences of words comprising sequences of words;
a process of dictating a repertory of synopses of words comprising synopses of words; and
a process of dictating a plurality of categories of synopses of words comprising synopses of words.

20. A method of efficient dictations adaptable to facilitate individuals' transcriptions of medical information comprises:
a means for abbreviating medical information;
a process of dictating said means for abbreviating medical information;
a process of dictating a repertory of sequences of words comprising sequences of words;
a process of dictating a plurality of categories of sequences of words comprising sequences of words;
a process of dictating a repertory of synopses of words comprising synopses of words; and
a process of dictating a plurality of categories of synopses of words comprising synopses of words.
